(19) United States
(12) Patent Application Publication
(10) Pub. No.: US 2013/0099889 A1
(43) Pub. Date: Apr. 25, 2013

(54) THERMAL FUSE SYSTEM FOR AN ELECTRICAL DEVICE

(71) Applicants: Rainer Durth, Horn-Bad Meinberg (DE); Christian Depping, Lemgo (DE); Thomas Meyer, Ottenstein (DE)

(72) Inventors: Rainer Durth, Horn-Bad Meinberg (DE); Christian Depping, Lemgo (DE); Thomas Meyer, Ottenstein (DE)

(21) Appl. No.: 13/638,116

(22) PCT Filed: Mar. 31, 2011
(86) PCT No.: PCT/EP2011/055022

§ 371 Date: Dec. 4, 2012

(30) Foreign Application Priority Data
Mar. 31, 2010 (DE) 1020100137677

(51) Int. Cl. H01H 37/36; H01H 37/46

(52) U.S. Cl. CPC H01H 37/36; H01H 37/46
USPC 337/306

(57) ABSTRACT

The invention concerns a system for thermal safeguarding of an electric device comprising several monitored components and/or monitoring points. According to the invention, the system comprises at least one thermosensitive element and one actuator coordinated with this thermosensitive element, wherein the thermosensitive element is configured as a sleeve or tube, to which the monitored components or monitoring points are thermally coupled, such that it undergoes a change in length or volume above a threshold temperature, and is connected to the actuator such that the actuator triggers an action in dependence on the change in length or volume of the thermosensitive element.

The invention concerns a system for thermal safeguarding of an electric device with several components to be monitored or monitoring points.

Monitoring and protecting of electric devices such as circuits, etc., against overheating is a long familiar problem and results from the fact that overloading and electrical aging of electronic components can lead to their damage or destruction due to short circuits, arcing, and so on.

However, a thermal monitoring becomes especially costly or impossible when several components are arranged in a limited construction space—as in the case of circuit boards. For such arrangements, therefore, a solution is usually chosen where each individual component is separately monitored, which makes the monitoring system costly and space-intensive. Furthermore, it is then usually impossible to accomplish a signaling of an overheating or an overloading, e.g., a display on the device or a remotely interrogated system.

The problem of the invention is to create a system for the safeguarding of an electric device in which one can easily accomplish a monitoring or protecting of components or important monitoring points against overheating.

The solution of the problem, according to the invention, is accomplished by the features of the object of patent claim 1. Advantageous modifications of the invention are indicated in the subclaims.

Accordingly, a system for thermal safeguarding of an electric device comprising several components and/or monitoring points to be monitored is characterized in that it comprises at least one thermosensitive element and one actuator coordinated with this thermosensitive element, wherein the thermosensitive element is configured as a sleeve or tube, to which the components or monitoring points to be monitored are thermally coupled, such that it undergoes a change in length or volume above a threshold temperature, and is connected to the actuator such that the actuator triggers an action in dependence on the change in length or volume of the thermosensitive element.

The term “electric device” includes, in particular, electric circuits, circuit boards, etc.

The term “monitoring points” in the sense of the present invention should be understood, in particular, such that certain locations in or at the electric device (even if no component is provided there) are to be thermally monitored. For example, an impermissible heating of conductors or printed tracks due to an overloading by too high a current should be identified.

The term “thermosensitive element” comprises, in the sense of the present invention, especially a material that undergoes a change in length or volume above a threshold temperature, the threshold temperature being the temperature above which the components and/or the electric device are to be protected or guarded against overheating.

The term “actuator” in the sense of the present invention should be taken in a broad sense and comprises, e.g., devices that trigger a signal, which can be mechanical and/or electrical, devices that interrupt or cut off the power supply of the electric device and/or individual components within it.

Such a system has at least one or more of the following advantages in many embodiments of the invention:

With the thermosensitive element it is possible to monitor at the same time several components, preferably all components on the electric device at the same time; this saves space, on the one hand, and is efficient, on the other. The thermosensitive element is so functional that its function is assured even without electric energy, so that the reliability of the system is improved. A signaling of a fault is possible thanks to the thermosensitive element along with the corresponding actuator.

According to one preferred embodiment of the invention, the thermosensitive element is arranged inside a tube that is essentially thermally shape-stable. The term “tube” is to be taken in the broad sense and can also comprise embodiments that are otherwise designated as “sleeve” or “conduit” or “capillary”.

If such an embodiment is chosen, when the thermosensitive element is correspondingly configured, a kind of Bowden cable is produced, so that the transmission of force to the actuator is improved and in particular the thermosensitive element or the tube need not be linear, but instead can be arranged in almost any way on or at the electric device.

According to one preferred embodiment of the invention, the material of the thermosensitive element undergoes a phase transition during the change in length or volume. Such an embodiment has the advantage that the change in length or volume occurs abruptly instead of gradually, i.e., the triggering of the actuator is more reliable.

According to one preferred embodiment of the invention, the material of the thermosensitive element undergoes a contraction during the change in length or volume. For this, it is preferred that the material of the thermosensitive element be chosen such that it contains a thermoplastic material, for example, one that has been cross linked after being extruded, such as the materials that are used in heat-shrink tubing. Suitable thermoplastic materials include polyolefins, PVC or fluorine-containing polymers like polyvinylidene fluoride, Teflon, fluorinated rubbers, etc. Equally preferred materials are shape-memory polymers. Preferably, a material will be chosen that contracts by a factor of 2 to 5 above the threshold temperature; such materials are, e.g., the fluoroelastomers of the Dupont Co. marketed under the brand name Viton. The thermosensitive element can also contain a shape-memory metal.

According to an alternative preferred embodiment of the invention, the material of the thermosensitive element undergoes an expansion during the change in length or volume. Here as well, the use of thermoplastic materials, shape-memory polymers and/or shape-memory metals is especially preferred.

According to one preferred embodiment of the invention, the thermosensitive element is provided as a liquid or viscous material inside the tube, fashioned as a capillary.

In this embodiment, it is especially advantageous for the thermosensitive element to contain a viscous material such as oil, wax, paraffin or suitable metals or alloys, such as lead and/or tin.

Preferably in this embodiment the capillary is closed at one end, and the actuator is arranged at the other end. This can be, e.g., a movable piston or a membrane. The change in length or volume of the thermosensitive element then acts directly on the actuator, which then brings about, e.g., a signal or an interruption.

According to one preferred embodiment of the invention, the change in length or volume of the thermosensitive element is reversible.

The aforementioned components as well as those claimed in the sample embodiments and to be used according to the invention are subject to no special boundary conditions in terms of their size, shape, choice of material and technical design, so that the criteria of selection known in this area of application can be applied without limitation.

Further details, features and advantages of the object of the invention will emerge from the subclaims, as well as the following description and accompanying drawings, in which several sample embodiments of the system of the invention are depicted—as examples. The drawing shows

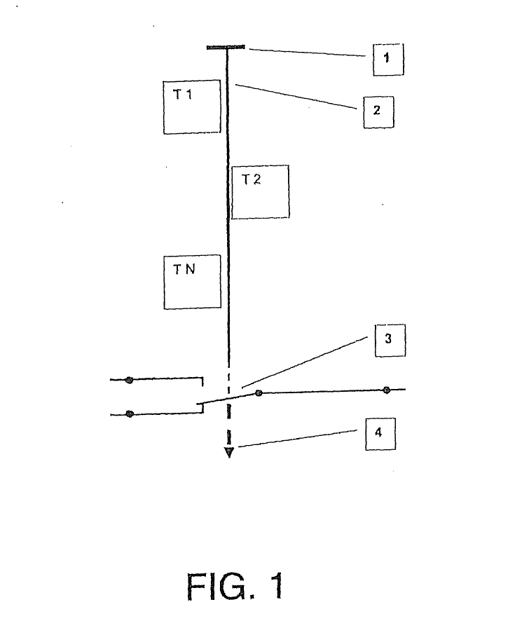

FIG. 1 a schematic representation of a system according to a first embodiment of the invention; and

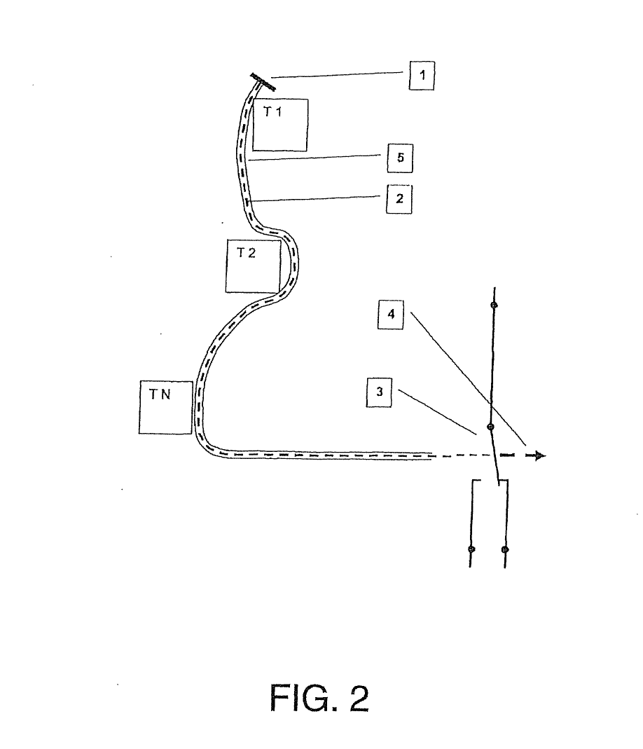

FIG. 2 a schematic representation of a system according to a second embodiment of the invention.

FIG. 1 shows a schematic representation of a system according to a first embodiment of the invention. According to FIG. 1, a thermosensitive element 2 is provided in the form of a welding rod, which is secured at one end to a support bearing 1. The thermosensitive element 2 runs along the various components T1, T2 to TN being thermally monitored such that it is thermally connected to them. At the other end of the thermosensitive element is the corresponding actuator 3 in the form of a switch. The thermosensitive element 2 comprises a material which contracts at the threshold temperature and can thus trigger the actuator 3. The latter can now either send out a signal, indicated by the arrow 4, or shut off or separate individual components or all components, for example.

FIG. 2 shows another schematic representation of a system according to a second embodiment of the invention. This differs from the embodiment of FIG. 1 in that the thermosensitive element 2 is arranged in a sleeve or tube 5, which is essentially shape-stable, i.e., it does not expand or contract when heated. This accomplishes a transmission of force in the manner of a Bowden cable. Thanks to this arrangement, the thermosensitive element 2 or tube 5 can also be arranged flexibly, i.e., in hoselike manner, on the electric device being monitored, as shown in FIG. 2.

Alternatively, of course, it is also possible to lead the thermosensitive element 2 by segments across rollers, etc., when no monitoring is required in this segment. But in the present instance, the thermosensitive element 2 should be arranged so that a tension on the actuator 3 arises when a component is overheated.

According to another embodiment not shown in the drawing, the tube or sleeve is fashioned as a capillary. By analogy with FIG. 2, this tube 5 is then closed at one end. The thermosensitive element 2 is then either a liquid or a viscous material such as wax or a metal (lead/tin) which expands when heated and thus activates the actuator 3.

The individual combinations of the constituent parts and the features of the already mentioned embodiments are given as examples; exchanging and substitution of this teaching with other teachings contained in this publication will also be considered expressly with the cited publications. The skilled person is aware that variations, modifications and other configurations that are described here can likewise occur without deviating from the notion of the invention and its scope.

Accordingly, the above description is an example and not to be taken as limiting. The word “comprise” used in the claims does not exclude other components or steps. The indefinite article “a” does not exclude the meaning of a plural form. The mere fact that certain measures are repeated in different claims does not mean that a combination of these measures cannot be used to advantage.

### LIST OF REFERENCE SYMBOLS

support bearing 1

thermosensitive element 2

actuator 3

signal transmission 4

tube 5

monitored components T1, T2, TN

1. An electric device with a system for thermal safeguarding of several components and/or monitoring points to be monitored, the electric device comprising:
at least one thermosensitive element; and
one actuator dedicated with the thermosensitive element
wherein the thermosensitive element is flexibly arranged on the electric device to be monitored in a sleeve or tube that is basically thermally shape-stable,
wherein the thermosensitive element is thermally coupled to the components or monitoring points to be monitored,
wherein the thermosensitive element is configured such that it undergoes a change in length or volume upon overheating of a component or monitoring point above a threshold temperature, and
wherein the thermosensitive element is connected to the actuator such that the actuator triggers an action in dependence on the change in length or volume of the thermosensitive element.

2. The electric device according to claim 1, wherein the action, which the actuator triggers in dependence on the change in length or volume of the thermosensitive element, is a signal.

3. The electric device according to claim 1, wherein an action, which the actuator triggers in dependence on the change in length or volume of the thermosensitive element, is a separating of the components and/or monitoring points from a power supply.

4. The electric device according to claim 1, wherein material of the thermosensitive element undergoes a phase transition during the change in length or volume.

5. The electric device according to claim 1, wherein material of the thermosensitive element undergoes a contraction during the change in length or volume.

6. The electric device according to claim 1, wherein material of the thermosensitive element undergoes an expansion during the change in length or volume.

7. The electric device according to claim 3, wherein the thermosensitive element is provided as a liquid or viscous material inside the tube being designed as a capillary.

8. The electric device according to claim 1, wherein the change in length or volume of the thermosensitive element is reversible.

9. The electric device according to claim 2, wherein material of the thermosensitive element undergoes a phase transition during the change in length or volume.

10. The electric device according to claim 9, wherein the thermosensitive element is provided as a liquid or viscous material inside the tube being designed as a capillary.

11. The electric device according to claim 9, wherein the change in length or volume of the thermosensitive element is reversible.

12. The electric device according to claim 2, wherein the material of the thermosensitive element undergoes a contraction during the change in length or volume.

13. The electric device according to claim 12, wherein the thermosensitive element is provided as a liquid or viscous material inside the tube being designed as a capillary.

14. The electric device according to claim 12, wherein the change in length or volume of the thermosensitive element is reversible.

15. The electric device according to claim 2, wherein material of the thermosensitive element undergoes an expansion during the change in length or volume.

16. The electric device according to claim 15, wherein the thermosensitive element is provided as a liquid or viscous material inside the tube being designed as a capillary.

17. The electric device according to claim 15, wherein the change in length or volume of the thermosensitive element is reversible.

18. The electric device according to claim 3, wherein material of the thermosensitive element undergoes a phase transition during the change in length or volume.

19. The electric device according to claim 3, wherein the material of the thermosensitive element undergoes a contraction during the change in length or volume.

20. The electric device according to claim 3, wherein material of the thermosensitive element undergoes an expansion during the change in length or volume.
